(19) United States
(12) Patent Application Publication
(10) Pub. No.: US 2006/0158602 A1
(43) Pub. Date: Jul. 20, 2006

(54) Method for manufacturing a function substrate, color filter substrate, liquid crystal display device, and electronic device

(75) Inventor: Naoyuki Toyoda, Suwa-shi (JP)

Correspondence Address: GLOBAL IP COUNSELORS, LLP, 1233 20TH STREET, NW, SUITE 700, WASHINGTON, DC, 20036-2680, US

(73) Assignee: Seiko Epson Corporation, Shinjuku-ku (JP)

(21) Appl. No.: 11/329,061

(22) Filed: Jan. 11, 2006

(30) Foreign Application Priority Data
Jan. 19, 2005 (JP) JP 2005-011174

(51) Int. Cl. B05D 5/12; B05D 5/06; G02F 1/1341; G02F 1/1339

(52) U.S. Cl. 349/189; 427/162; 427/58; 349/190

(57) ABSTRACT

A method for manufacturing a function substrate is to be used in a liquid crystal display device having a black matrix. The method includes forming a liquid repelling layer that covers a surface of a substrate; irradiating through a mask pattern with light a first part of the liquid repelling layer that corresponds to the black matrix, such that the liquid repellency of the first part is reduced relative to that of other parts of the liquid repelling layer; and covering the liquid repelling layer, after the irradiation, with a dispersion fluid in which spacers are dispersed.

### BACKGROUND

1. Technical Field

The present invention relates to a method for manufacturing a function substrate, color filter substrate, liquid crystal display device, and electronic device.

2. Related Art

In a liquid crystal display device, maintaining the liquid crystal thickness (cell gap) is a factor in preserving the high precision of the display. The cell gap must be uniformly maintained along the display surface of the liquid crystal display device. Cell gap accuracy is approximately ±0.1 μm in the case of a liquid crystal display device provided with TFT (thin film transistors) as switch elements, and approximately ±0.03 μm in the case of an STN liquid crystal display device.

In order to obtain a uniform cell gap, micro particle spacers are mixed in the liquid crystal material and dispersed between substrates. In this method, there are times the micro particle spacers contaminate the pixel regions. The display image is adversely affected when the micro particle spacers are positioned in the pixel regions since scattered light is generated at the interface between the liquid crystal material and the micro particle spacers. Furthermore, when the display surface (display screen) of the liquid crystal display device is enlarged, it becomes difficult to uniformly distribute the micro particle spacers along the entire surface of the display area.

Art employing a photo resist has been proposed in which the photo resist is selectively left on parts corresponding to the black matrix, such that the residual photo resist is used as a spacer. The spacer configured by such a residual photo resist is also referred to as a post spacer. In this art, it becomes difficult to uniformly apply the resist itself when the display area is enlarged.

JP-A-5-188211 below discloses a method for manufacturing a color filter wherein a light shield layer is positioned in gap regions between a plurality of pixel regions on a transparent substrate, and a transparent colored layer is respectively positioned in the plurality of pixel regions; the method of manufacture is described below.

According to JP-A-5-188211, a photosetting adhesive layer is formed on one surface of a transparent colored layer, and micro particle spacers are distributed on the formed photosetting adhesive layer. Then, the photosetting adhesive layer of the pixel regions and the micro particle spacers on the photosetting adhesive layer are removed by selectively exposing to light the part of the photosetting adhesive layer corresponding to the light shield layer so as to cure the photosetting adhesive layer.

In the above methods of manufacture, it is invariably necessary to wash the residue remaining in the pixel areas (pixel regions). In the case of post spacers, for example, a residue of organic material remains after the photo resist has been removed by patterning. In the case of JP-A-5-188211, a residue of the photo setting adhesive layer also remains even after the photosetting adhesive layer and micro particle spacers have been developed and removed from the pixel regions.

### SUMMARY

In view of these problems, one of the advantages of the invention is to provide a method for arranging spacers only in areas corresponding to a black matrix without including a process of cleaning away a residue.

An aspect of the invention provides a method for manufacturing a function substrate to be used in a liquid crystal display device having a black matrix. The method includes forming a liquid repelling layer that covers a surface of a substrate; irradiating through a mask pattern with light a first part of the liquid repelling layer that corresponds to the black matrix, such that the liquid repellency of the first part is reduced relative to that of other parts of the liquid repelling layer; and covering the liquid repelling layer, after the irradiation, with a dispersion fluid in which spacers are dispersed.

Here, the liquid repellency of the area (first area) corresponding to the black matrix is lower than the liquid repellency of other areas. Therefore, the dispersion fluid in which the spacers are dispersed collects from the other areas in the area corresponding to the black matrix. The black matrix is a light shielding pattern regulating the pixel region, while the other areas correspond to the pixel region. That is, there is no residue of the spacers or dispersion fluid in the pixel region.

The method for manufacturing a function substrate preferably further including providing a photocatalyst layer on the surface of the substrate. In this case, the liquid repelling layer is formed on the photocatalyst layer. It is desirable that the photocatalyst layer is formed by providing on the surface micro particles of one or more materials selected from among silica, titanium oxide, zinc oxide, tin oxide, strontium titanate, tungsten oxide, bismuth oxide, and iron oxide.

Here, the liquid repelling layer can be readily patterned.

Preferably, the forming of the liquid repelling layer includes forming a high polymer compound containing fluorine on the surface as the liquid repelling layer.

Preferably, the forming of the liquid repelling layer includes forming on the surface of the substrate an organic film formed of organic molecules containing fluorine as the liquid repelling layer. Still further, the forming of the liquid repelling layer preferably includes introducing fluorine on the surface of the substrate using a fluorocarbon compound in a reaction gas, and thereby forming the liquid repelling layer.

Yet further, the forming of the liquid repelling layer preferably includes forming on the surface of the substrate an organic film formed of organic molecules with a hydrocarbon chain of four or more carbon atoms as the liquid repelling layer. Still further, the forming of the liquid repelling layer preferably includes forming on the surface of the substrate a photosensitive molecule layer as the liquid repelling layer.

The color filter substrate of another aspect of the invention is produced by the previously mentioned method for manufacturing a function substrate. Furthermore, the liquid crystal display device of still another aspect of the present invention is provided with the color filter substrate. Moreover, the electronic device of still another aspect of the present invention is provided with the liquid crystal display device.

### BRIEF DESCRIPTION OF THE DRAWINGS

FIGS. 1A through D show the manufacturing method of a first embodiment;

FIGS. 2A through D show the manufacturing method of the first embodiment;

FIG. 3 is a schematic view of a liquid crystal display device of the present embodiment;

FIGS. 4A through D show the manufacturing method of a second embodiment;

FIGS. 5A through D show the manufacturing method of the second embodiment;

FIG. 6 is a schematic view of a color filter substrate of the second embodiment;

FIGS. 7A through D show the manufacturing method of a third embodiment;

FIGS. 8A through D show the manufacturing method of the third embodiment;

FIGS. 9A through D show the manufacturing method of the third embodiment;

FIGS. 10A through D show the manufacturing method of a fourth embodiment;

FIGS. 11A through D show the manufacturing method of the fourth embodiment;

FIG. 12 is a schematic view of a color filter substrate of the fourth embodiment;

FIG. 13 is a schematic view of a portable telephone provided with the liquid crystal display devices of the first through fourth embodiments; and

FIG. 14 is a schematic view of a personal computer provided with the liquid crystal display devices of the first through fourth embodiments.

### DESCRIPTION OF EXEMPLARY EMBODIMENTS

The first through fourth embodiments are described below in terms of the method for manufacturing the color filter substrate as a function substrate. Like structural elements are designated by like reference numbers throughout the first through fourth embodiments, and repetitive descriptions of like structural elements are omitted.

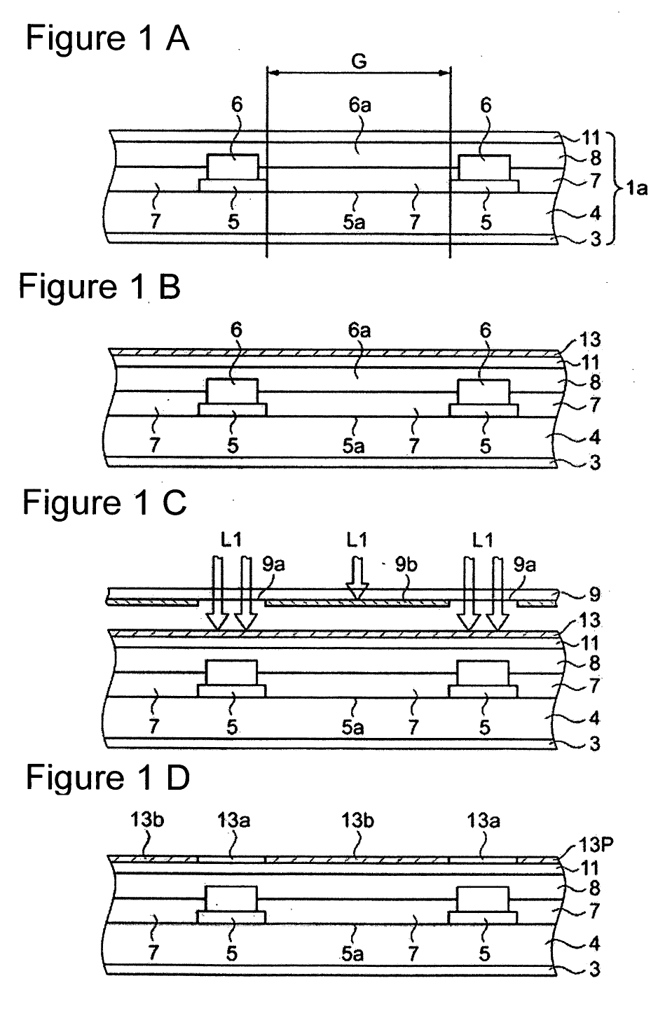

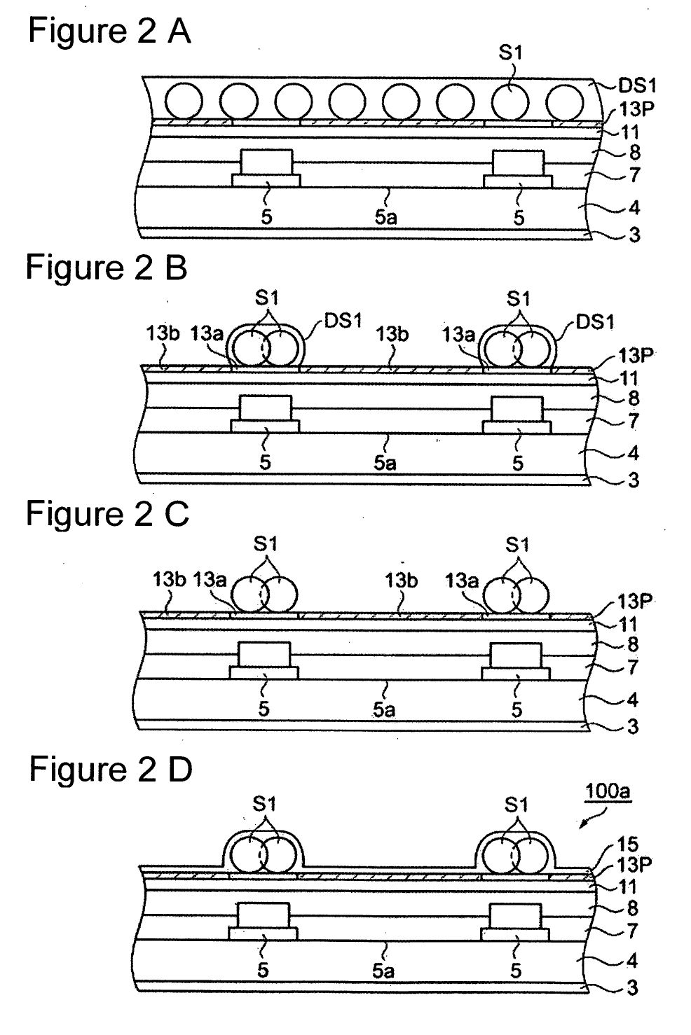

A base 1a shown in FIG. 1A is provided with a structure that includes a color filter substrate 100a (FIG. 2D) through a process described later. Specifically, the base 1a is provided with a polarization panel 3, light transmitting substrate 4, black matrix 5 positioned on the substrate 4, bank pattern 6, plurality of color filter elements 7, overcoat layer 8, and common electrode 11 on the overcoat layer 8.

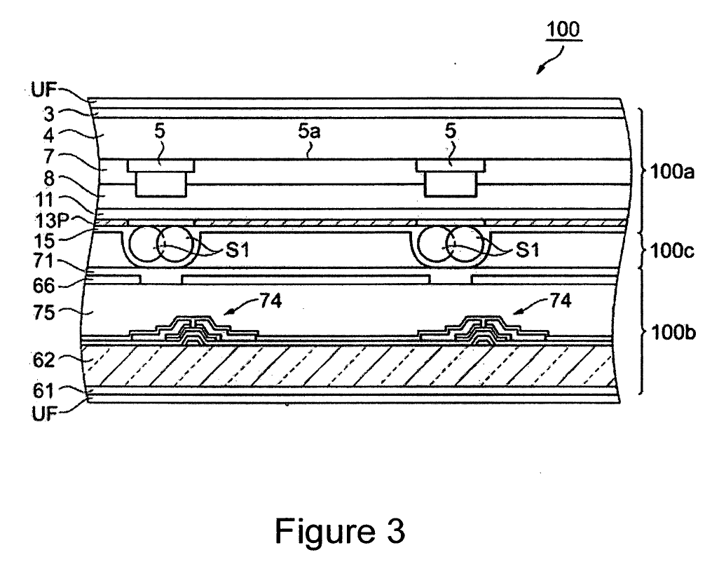

The black matrix 5 is a light shield pattern for providing a plurality of light transmitting parts 5a. The black matrix 5 further provides a plurality of pixel regions G in the liquid crystal display device. Specifically, the plurality of light transmitting parts 5a respectively correspond to a plurality of pixel electrodes 66 (FIG. 3) in an element substrate 100b described later. More specifically, when the liquid crystal display device is assembled, the plurality of light transmitting parts 5a respectively overlay the corresponding pixel electrodes 66. The plurality of light transmitting parts in the present embodiment are apertures provided in the black matrix 5.

The bank pattern 6 is positioned on the black matrix 5. The bank pattern 6 has a shape that regulates a plurality of apertures 6a. The plurality of apertures 6a respectively overlay the plurality of light transmitting parts 5a provided by the black matrix 5.

The plurality of color filter elements 7 are respectively positioned within the plurality of apertures 6a provided by the ban pattern 6. The plurality of color filter elements 7 of the present embodiment are provided using an inkjet method. When the color filter elements 7 are formed using the inkjet method, it is beneficial to provide the bank pattern 6 since the bank pattern 6 catches the liquid filter material, which is the raw material of the color filter element. The bank pattern 6 is not required, however, when the plurality of color filter elements 7 are formed using a method other than the inkjet method.

The overcoat layer 8 covers the plurality of color filter elements 7 and the bank pattern 6. The thickness of the overcoat layer 8 is set such that the overcoat layer 8 absorbs the difference in levels formed by the color filter elements 7 and bank pattern 6. Thus, the surface with the overcoat layer 8 is substantially flat regardless of the underlying difference in levels.

The common electrode 11 is positioned on the overcoat layer 8. The common electrode 11 is an ITO electrode, therefore the common electrode 11 has light transmitting properties. The common electrode 11 is an electrode (single electrode) corresponding to all the plurality of pixel electrodes 66 (FIG. 3) in the liquid crystal display device. That is, when the liquid crystal display device is assembled, the common electrode 11 opposes all the plurality of pixel electrodes 66.

The polarization panel 3 is positioned on the surface on the side opposite the black matrix 5 of the substrate 4. In the present embodiment, the polarization panel 8 is included in the base 1a. The polarization panel 8 is not necessarily a structural element of the base 1a. That is, the base 1a and the polarization panel 3 may be configured as separate structural elements.

Manufacturing Method

The method of manufacturing the color filter substrate is described below with reference to FIGS. 1 and 2. First, the opposing electrode 11 is formed on the overcoat layer 8 by a spatter vapor deposition method, as shown in FIG. 1A.

Then, a liquid repelling layer 13 is provided to cover the common electrode 11, as shown in FIG. 1B. Specifically, a liquid containing liquid repelling macromolecules is applied on the common electrode 11 using a spin coat method to form a liquid repelling macromolecule layer, that is, an organic film. “Unidyne,” which can be obtained from Daikin Industries, K.K., may be used as the fluid containing liquid repellent macromolecules. Then, the applied liquid repelling macromolecule layer is heat treated for 2 minutes at 120° C. to obtain a liquid repelling layer 13 having a thickness of approximately 200 nm. To facilitate the following description, the part of the liquid repelling layer 13 corresponding to the black matrix 5 is referred to as the “first part 13a.” Moreover, the part corresponding to the light transmitting area regulated by the black matrix 5 is referred to as the “second part 13b.” The organic layer of the applied fluid containing the liquid repelling macromolecules is an example of a film of a macromolecular compound containing fluorine of the present embodiment. The thickness of the liquid repelling layer 13 may be within a range of 50 to 1000 nm.

Oligomers or polymers containing fluorine atoms in the molecules may be used as the macromolecular compound containing fluorine. Useful examples of macromolecular compounds containing fluorine include polytetrafluoroethylene (PTFE), ethylene-tetrafluoroethylene copolymer, hexafluoropropylene-tetrafluoroethylene copolymer, polyfluorovinylidene PVdF), poly(pentadecafluoroheptylethylmethacrylate) (PPFMA), poly(perfluorooctylethylacrylate) and like ethylenes having long chain perfluoroalkyl structures, esters, acrylates, methacrylates, vinyls, urethanes, silicons, imides, and carbonate polymers.

A liquid repelling pattern 13p is formed for patterning the liquid repelling layer 13, as shown in FIGS. 1C and 1D. Specifically, the liquid repelling pattern 13p is formed by reducing the degree of liquid repellency of the first part 13a to less than the degree of liquid repellency of the second part 13b.

More specifically, The liquid repelling layer 13 is irradiated through the mask pattern 9 by a light L1 having a wavelength of 172 nm or 254 nm. The mask pattern 9 has a light transmitting part 9a corresponding to the black matrix 5, and a light blocking part 9b corresponding to the plurality of pixel regions G. The light L1 irradiates the light transmitting part 9a of the mask pattern 9 overlaying the black matrix 5. As a result, the first part 13a of the liquid repellency layer 13 is irradiated by the light L1 having a wavelength of 172 nm or 254 nm. The second part 13b of the liquid repellency layer 13 is not irradiated by the light L1.

As shown in FIG. 1D, the degree of liquid repellency of the first part 13a is reduced to less than the degree of liquid repellency of the second part 13b by the irradiation of the first part 13a by light having the above mentioned wavelength. Specifically, the difference between the contact angle formed by the first part 13a and a dispersion fluid DS1 (FIG. 2) described layer, and the contact angle formed by the second part 13b and the dispersion fluid DS1 is 10° or greater.

More specifically, the light of the above mentioned wavelength causes dissociation, cleavage, migration, and oxidation of the molecules in the first part 13a, and bonding among like molecules in the first part 13a, or bonding of hydrogen atoms or oxygen atoms in the first part 13a. Then, the first part 13a becomes lyophilic relative to the dispersion fluid DS1 (FIG. 2) by the chemical reaction produced in the first part 13a. In the present embodiment, the contact angle of the light of the previously mentioned wavelength relative to the water of the first part 13a is less than 80°. The contact angle of the second part 13b relative to water is maintained at 90° or greater.

Then, as shown in FIG. 2A, a dispersion fluid DS1 is provided or applied on the liquid repelling pattern 13p. The dispersion fluid DS1 includes water, which functions as a dispersion medium, and spacers S1, which have a 4 μm diameter and are dispersed in the water. Beads treated with a thermal surface hardening process produced by Sekisui Chemical Co., Ltd., may be used as the spacers S1. When the dispersion fluid DS1 is provided so as to cover the liquid repelling pattern 13p, the dispersion fluid DS1 is self-assembled or self-arranged relative according to the liquid repelling pattern 13p, as shown in FIG. 2B. Specifically, nearly all of the dispersion fluid DS1 collects in the first part 13a, which has lower relative liquid repellency, by means of the surface tension of the dispersion fluid DS1. In this case, the water dispersion medium and the spacers S1 collect in the first part 13a. Moreover, neither the dispersion medium nor the spacers S1 remain in the second part 13b, which has a higher liquid repellency. Since the dispersion medium is water, there is no residue remaining in the pixel region G or the second part 13b.

Since the part corresponding to the pixel region G (second part 13b) still has liquid repellency, the spacers S1 can be removed from the part where the spacers S1 should not remain (second part 13b) when, for example, the dispersion fluid DS1 is uniformly applied to the liquid repelling pattern 13p. Thus, since no spacers S1 remain in the pixel region G, there is no light scattering caused by the spacers S1 when an image is displayed on the liquid crystal display device.

Thereafter, the base 1a provided with the spacers S1 is heated to evaporate the dispersion fluid (water), as shown in FIG. 2C. Finally, a thermosetting resin configuring the surface of the spacers S1 is hardened by this heating. Then, like spacers S1 are not only mutually adhered on the first part 13a, the spacers S1 are also adhered to the surface of the first part 13a.

Then, as shown in FIG. 2D, an orientation film 15 is formed to cover the spacers S1 on the first part 13a, and the second part 13b. The thickness of the orientation film 15 is approximately 30 nm. Then, when the obtained orientation film 15 has been subjected to a rubbing process, the base 1a becomes the color filter substrate 100a.

Thereafter, an separately manufactured element substrate 100b is adhered to the color filter substrate 100a. In this case, the color filter substrate 100a and the element substrate 100b are positioned such that the orientation film 15 of the color filter substrate 100a ands the orientation film 71 of the element substrate 100b are mutually facing. The orientation film 15 corresponding to the first part 13a overhangs the orientation film 15 corresponding to the second part 13b by a distance equivalent to the diameter of the underlying spacers S1. Therefore, when the color filter substrate 100a and the element substrate 100b are adhered, a gap corresponding to the diameter of the spacer S1 is created between the color filter substrate 100a and the element substrate 100b. This gap is filled with liquid crystal material to form a liquid crystal layer 100c. Thus, the liquid crystal display device 100 is obtained, as shown in FIG. 3.

As shown in FIG. 3, the liquid crystal display device 100 may also be provided with two ultraviolet filters UF in addition to the previously described structural elements. In this case, the two ultraviolet filters UF are provided such that the color filter substrate 100a, element substrate 100b, and liquid crystal layer 100c are disposed between the two ultraviolet filters UF. This disposition prevents deterioration of the polarization panels 3 and 61 by ultraviolet light included in the exterior light and ultraviolet light included in the light from the light source. Moreover, if the ultraviolet light from the exterior light has an intensity that can be ignored, the ultraviolet light filter UF may be omitted on the side from which the exterior light enters. Furthermore, if the ultraviolet light include din the light from the light source can be ignored, as in the case of an LED light source, the ultraviolet filter also may be omitted on the light source side.

(Element Substrate)

The element substrate 100b shown in FIG. 3 is provided with a light transmitting substrate 62, a plurality of source signal wires and plurality of gate signal wires not shown in the drawing, a plurality of switching elements 74 positioned on the substrate, an interlayer insulating film 75 for absorbing the difference in levels of the plurality of switching elements 74, a plurality of pixel electrodes 66 positioned on the interlayer insulating film 75, and an orientation film 71 covering the plurality of pixel electrodes 66. Through holes not shown in the drawing are provided in the interlayer insulating film 75, such that the plurality of switching elements 74, and the plurality of pixel electrodes 66 are electrically connected through the through holes.

As shown in FIG. 3, the manufacturing method of the present embodiment ensures that the spacers S1 for maintaining a gap collect only in the part corresponding to the black matrix 5. That is, the spacers S1 do not enter the pixel region G. Furthermore, since the spacers S1 do not enter the pixel region G, there is no scattered light produced by the spacers S1. Since the dispersion medium is water, there is no possibility of the dispersion medium remaining in the pixel region G, and, therefore, there is no need to wash residue from the pixel region G. Accordingly, the manufacturing method of the present embodiment provides a liquid crystal display device 100 that realizes an excellent display.

Furthermore, the black matrix 5 is provided in the color filter substrate 100a in the present embodiment. However, as an alternative to this configuration, the black matrix 5 also may be provided in the element substrate 100b. In this case, when a plurality of source signal wires themselves and a plurality of gate signal wires themselves function as a black matrix 5 in the element substrate 100b, the black matrix 5 described in the present embodiment may be omitted. In this case, the plurality of source signal wires and plurality of gate signal wires are equivalent to the black matrix of the present embodiment.

The dispersion fluid DS1 also may be applied to the element substrate 100b. In this case, either the surface of the interlayer insulating film 75 or the surfaces of a plurality of pixel electrodes 66 are equivalent to the surface of the substrate of the present embodiment. Also, in this instance, the element substrate 100b shown in FIG. 3 is equivalent to the function substrate of the present embodiment. Thus, either of the color filter substrate 100a or element substrate 100b is equivalent to the function substrate of the present embodiment.

### Second Embodiment

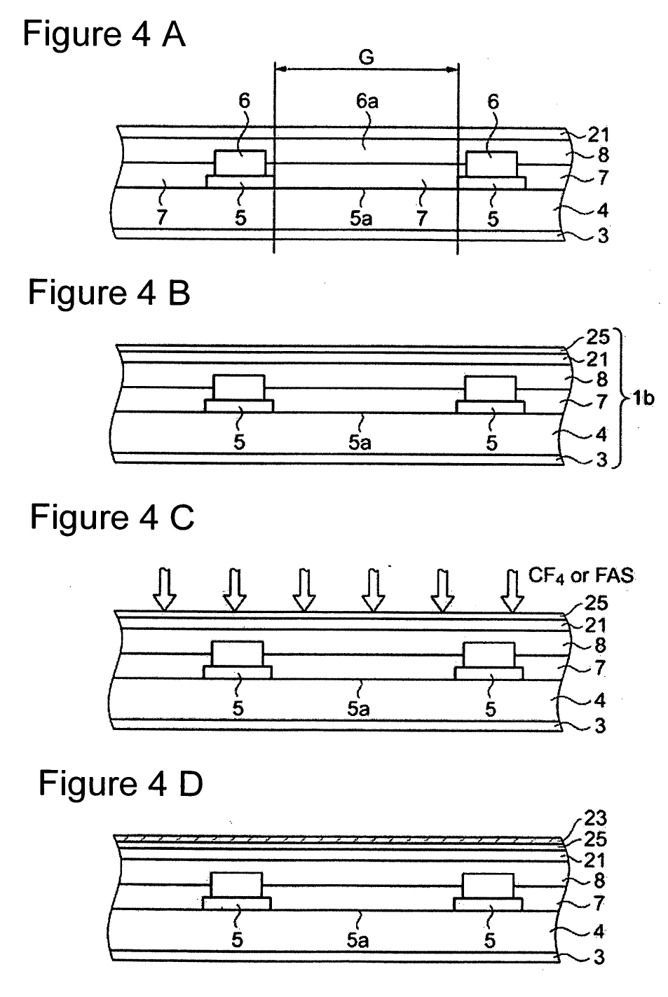

In the second embodiment, the common electrode 21 is first formed on the overcoat layer 8 using a spatter vacuum deposition method, as shown in FIG. 4A. Then, an orientation film 25 is formed to cover the common electrode 21, as shown in FIG. 4B. Specifically, the orientation film 25 is obtained by forming a polyimide film of approximately 30 nm in thickness on the common electrode 21, then subjecting the obtained polyimide film to a rubbing process.

The base 1b of the present embodiment includes a polarization panel 3, substrate 4, color filter element 7, black matrix 5, bank pattern 6, overcoat layer 8, common electrode 21, and orientation film 25. The surface of the orientation film 25 is equivalent to the surface of the substrate of the present embodiment.

Next, a liquid repelling layer 23 is formed to cover the orientation film 25, as shown in FIGS. 4C and 4D.

Specifically, the orientation film 25 is subjected to plasma processing using a fluorocarbon gas in a reaction gas to introduce fluorine atoms into the surface of the orientation film 25. The reaction gas in the present embodiment is CF₄. In the present embodiment, the surface of the orientation film 25 including the introduced fluorine atoms is equivalent to the liquid repelling layer 23. Similar to the first embodiment, the part of the liquid repelling layer 23 corresponding to the black matrix 5 is designated the first part 23a. Moreover, the part corresponding to the light transmitting area 5a regulated by the black matrix 5 is referred to as the “second part 23b.”

The methods for forming the liquid repelling layer 23 on the orientation film 25 may include a process of forming an FAS (fluoroalkylsilane) film on the orientation film 25 as an alternative to using the plasma process. In this case, substrate provided with the orientation film 25 may be stored in a sealed FAS atmosphere. In this case, the FAS film is formed on the orientation film 25 by chemical vapor phase absorption. Then, since the thus-formed FAS film has liquid repellency relative to the dispersion fluid DS2, the FAS film is the liquid repelling layer 23 of the present embodiment. The FAS film is an example of an organic film configured by organic molecules containing fluorine atoms. The thickness of the FAS film is regulated so as to be less than 100 nm.

Surface-active agent or silane coupling agent (organic silicon compound) in which the terminal function groups of the molecules selectively chemically bond to atoms configuring the surface of the substrate may be used as the organic molecules containing fluorine. FAS indicates these general compounds.

The silane coupling agent is a compound represented by R¹SiX¹ₘX²₍₃₋ₘ₎, where R¹ represents an organic group, X¹ and X² represent either —OR², —R², or —Cl, R² represents an alkyl group with 1˜4 carbon atoms, and m represents an integer from 1˜3.

The silane coupling agent chemically adheres to the hydroxyl group in the surface of the substrate. Furthermore, the silane coupling agent is applicable for use as a liquid repelling agent since it is reactive with oxides on the surface, including a broad range of materials such as metals and insulators and the like. When R¹ has a perfluoroalkyl structure CₙF₂ₙ₊₁, or a perfluoroalkyl ether structure CₚF₂ₚ₊₁O (CₚF₂ₚO)ᵣ, the free surface energy of the organic film formed by the silane coupling agent becomes lower than 25 mJ/m², thus reducing the affinity of materials having a polarity. Therefore, it is desirable to use silane coupling agents wherein R¹ has a perfluoroalkyl structure CₙF₂ₙ₊₁, or a perfluoroalkyl ether structure CₚF₂ₚ₊₁O(CₚF₂ₚO)ᵣ.

More particularly, examples of useful silane coupling agents include CF₃—CH₂C H₂—Si(OCH₃)₃, CF₃(CF₂)₃—CH₂CH₂—Si(OCH₃)₃, CF₃(CF₂)₅—CH₂CH₂—Si(OCH₃)₃, CF₃(CF₂)₅—CH₂CH₂—Si(OC₂H₅)₃, CF₃(CF₂)₇—CH₂CH₂—Si(OCH₃)₃, CF₃(CF₂)₁₁—CH₂CH₂—Si(OC₂H₅)₃, CF₃(CF₂)₃—CH₂CH₂—Si(CH₃)(OCH₃)₂, CF₃(CF₂)₇—CH₂CH₂—Si(CH₃)(OCH₃)₂, CF₃(CF₂)₈—CH₂CH₂—Si(CH₃)(OC₂H₅)₂, CF₃(CF₂)₈—CH₂CH₂—Si(C₂H₅)(OC₂H₅)₂, CF₃O(CF₂O)₆—CH₂CH₂—Si(OC₂H₅)₃, CF₃O(C₃F₆O)₄—CH₂CH₂—Si(OCH₃)₃, CF₃O(C₃F₆O)₂(CF₂O)₃—CH₂CH₂—Si(OCH₃)₃, CF₃O(C₃F₆O)₈—CH₂CH₂—Si(OCH₃)₃, CF₃O(C₄F₉O)₅—CH₂CH₂—Si(OCH₃)₃, CF₃O(C₄F₉O)₅—CH₂CH₂—Si(CH₃)(OC₂H₅)₂, CF₃O(C₃F₆O)₄—CH₂CH₂—Si(C₂H₅)(OCH₃)₂ and the like. The silane coupling agent is not limited to these structures.

Other than silane coupling agents, surface active agents also may be used as organic molecules containing fluorine. Surface active agents are compounds represented by R¹Y¹, where Y¹ is a hydrophilic polar group, such as —OH, —(CH₂CH₂O)ₙH, —COOH, —CO OK, —COONa, —CONH₂, —SO₃H, —SO₃Na, —OSO₃H, —OSO₃Na, —PO₃H₂, —PO₃Na₂, —PO₃K₂, —NO₂, —NH₂, —NH₃Cl (ammonium salt), —NH₃Br (ammonium salt), ≡—NHCl (pyridinium salt), ≡NHBr (pyridinium salt) and the like. Although R¹ is configured by a hydrophobic function group, when R¹ has a perfluoroalkyl structure CₙF₂ₙ₊₁, or a perfluoroalkyl ether structure CₚF₂ₚ₊₁O(CₚF₂ₚO)ᵣ, the free surface energy of the organic film formed by the silane coupling agent becomes lower than 25 mJ/m², thus reducing the affinity of materials having a polarity. Therefore, it is desirable to use surface active agents wherein R¹ has a perfluoroalkyl structure CₙF₂ₙ₊₁, or a perfluoroalkyl ether structure CₚF₂ₚ₊₁O(CₚF₂ₚO)ᵣ.

More particularly, examples of useful surface active agents include CF₃—CH₂CH₂—COONa, CF₃(CF₂)₃—CH₂CH₂—COONa, CF₃(CF₂)₃—CH₂CH₂—NH₃Br, CF₃(CF₂)₅—CH₂CH₂—NH₃Br, CF₃(CF₂)₇—CH₂CH₂—NH₃Br, CF₃(CF₂)₇—CH₂CH₂—OSO₃Na, CF₃(CF₂)₁₁—CH₂CH₂—NH₃Br, CF₃(CF₂)₈—CH₂CH₂—OSO₃Na, CF₃O(CF₂O)₆—CH₂CH₂—OSO₃Na, CF₃O(C₃F₆O)₂(CF₂O)₃—CH₂CH₂—OSO₃Na, CF₃O(C₃F₆O)₄—CH₂CH₂—OSO₃Na, CF₃O(C₄F₉O)₅—CH₂CH₂—OSO₃Na, CF₃O(C₃F₆O)₈—CH₂CH₂—OSO₃Na and the like. The surface active agent is not limited to these structures.

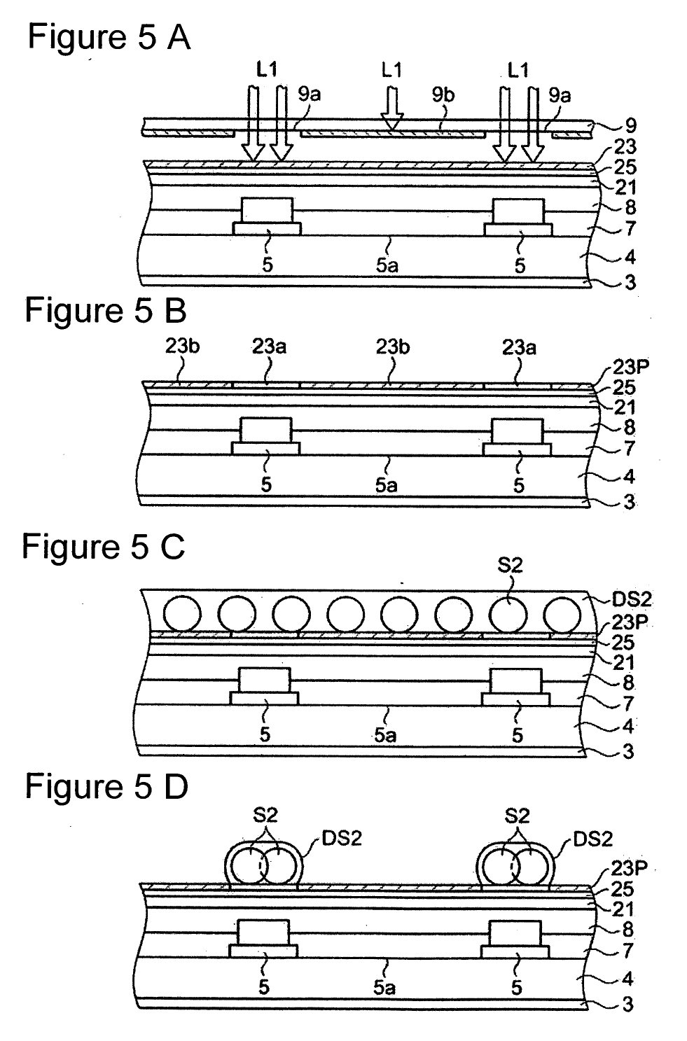

Next, the liquid repelling layer 23 is patterned to form the liquid repelling pattern 23p, as shown in FIGS. 5A and 5B. Specifically, the liquid repelling pattern 23p is formed by reducing the degree of liquid repellency of the first part 23a to less than the degree of liquid repellency of the second part 23b.

More specifically, the liquid repelling layer 23 is irradiated through the mask pattern 9 by a light L1 having a wavelength of 172 nm or 254 nm. The mask pattern 9 has a light transmitting part 9a corresponding to the black matrix 5, and a light blocking part 9b corresponding to the plurality of pixel regions G. The light L1 irradiates the light transmitting part 9a of the mask pattern 9 overlaying the black matrix 5. As a result, the first part 23a of the liquid repellency layer 23 is irradiated by the light L1 having a wavelength of 172 nm or 254 nm. The second part 23b of the liquid repellency layer 23 is not irradiated by the light L1.

As shown in FIG. 5B, the degree of liquid repellency of the first part 23a is reduced to less than the degree of liquid repellency of the second part 23b by the irradiation of the first part 23a by light having the above mentioned wavelength. Specifically, the difference between the contact angle formed by the first part 23a and a dispersion fluid DS2 (FIG. 5C) described layer, and the contact angle formed by the second part 23b and the dispersion fluid DS2 is 10° or greater.

More specifically, there is dissociation, cleavage, migration, and oxidation of the molecules in the first part 23a, and bonding among like molecules in the first part 23a, or bonding of hydrogen atoms or oxygen atoms in the first part 23a. Then, the first part 13a becomes lyophilic relative to the dispersion fluid DS1 (FIG. 2) by the chemical reaction produced in the first part 13a. In the present embodiment, the contact angle of the light of the previously mentioned wavelength relative to the water of the first part 23a relative is less than 80°. The contact angle relative to the water of the second part 23b is maintained at 90° or greater.

Then, a dispersion fluid DS2 is provided or applied on the liquid repelling pattern 23p, as shown in FIG. 5C. The dispersion fluid DS2 includes water, which functions as a dispersion medium, and spacers S2, which have a 2 μm diameter and are dispersed in the water. Natco spacers, manufactured by Natco Company, Ltd., may be used as the spacers S2. When the dispersion fluid DS2 is provided so as to cover the liquid repelling pattern 23p, the dispersion fluid DS2 is self-organized or self-arranged relative to the liquid repelling pattern 23p, as shown in FIG. 5D. Specifically, nearly all of the dispersion fluid DS2 collects in the first part 23a which has lower relative liquid repellency by means of the surface tension of the dispersion fluid DS2. In this case, the water dispersion medium and the spacers S2 collect in the first part 23a. Moreover, neither the dispersion medium nor the spacers S2 remain in the second part 23b, which has a higher liquid repellency. Since the dispersion medium is water, there is no residue remaining in the pixel region G or the second part 23b.

Since the liquid repellency remains in the part corresponding to the pixel region G (second part 23b), the spacers S2 can be removed from the part where the spacers S2 should not remain (second part 23b), for example, even when the dispersion fluid DS2 is uniformly applied to the liquid repelling pattern 23p. Thus, since no spacers S2 remain in the pixel region G, there is no light scattering caused by the spacers S2 when an image is displayed on the liquid crystal display device.

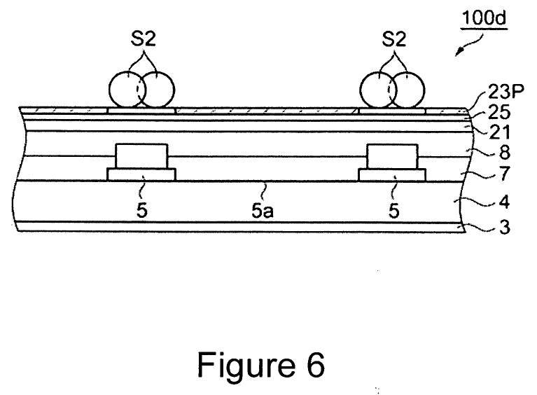

Thereafter, the base 1b provided with the spacers S2 is heated to evaporate the dispersion medium (water), as shown in FIG. 6. Then, the spacers S2 remain only in the first part 23a.

The color filter substrate 100d of the present embodiment is formed by the above processes. Thereafter, the element substrate 100b described in the first embodiment is adhered to the color filter substrate 100d. Then, liquid crystal material is loaded in the gap between the element substrate 100b and the color filter substrate 100d to form a liquid crystal layer 100c, and thus obtain a liquid crystal display device.

### Third Embodiment

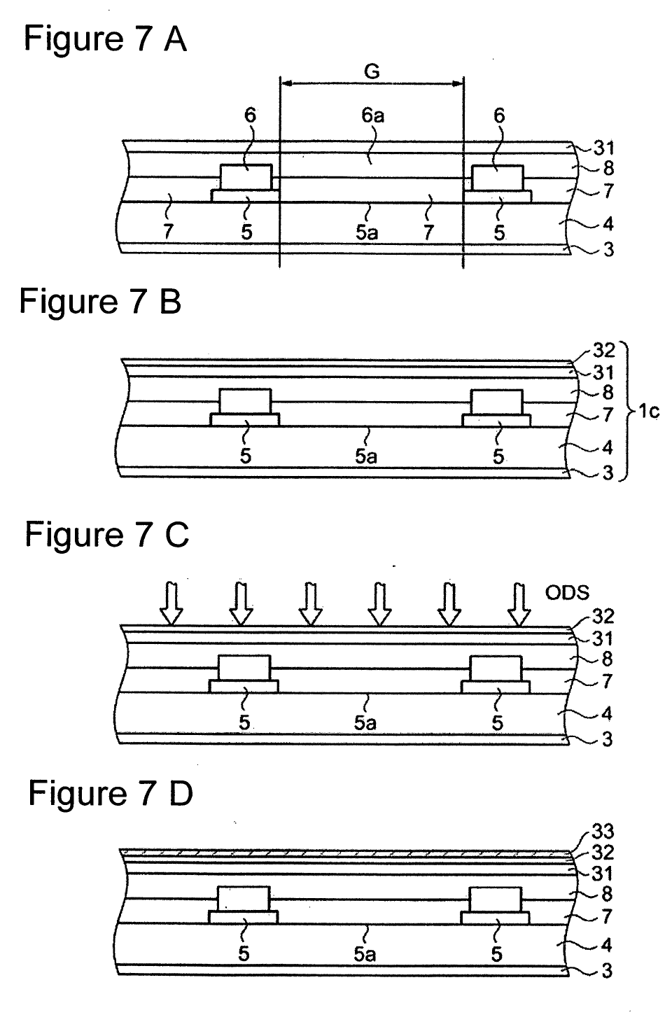

In the third embodiment, an ITO common electrode 31 is formed on the overcoat layer 8 using a spatter vacuum deposition method, as shown in FIG. 7A. Then, photocatalyst micro particles are applied onto the common electrode 31 so as to form a photocatalyst layer 32 covering the common electrode 31, as shown in FIG. 7B. The product [ST-K211], which is obtainable from Ishihara Sangyo Kaisha, Ltd., may be used as the photocatalyst micro particles.

The photocatalyst layer 32 of the present embodiment includes titanium oxide (TiO₂) and silica (SiO₂) as major components. However, micro particles may be formed of one or more materials selected from among silica (SiO₂), titanium oxide (TiO₂), zinc oxide (ZnO), tin oxide (SnO₂), strontium titanate (SrTi₃), tungsten oxide (WO₃), bismuth oxide (Bi₂O₃), and ferrous oxide (Fe₂O₃). When such micro particles are used, the micro particles may be applied onto the overcoat layer 8.

The base 1c of the present embodiment includes a polarization panel 3, a substrate 4, a color filter element 7, a black matrix 5, a bank pattern 6, an overcoat layer 8, a common electrode 31, and a photocatalyst layer 32, as shown in FIG. 7B. The surface of the photocatalyst layer 32 is equivalent to the surface of the base of the present embodiment.

After the photocatalyst layer 32 has been formed, the base 1c is place din an ODS (octadecylsilane) atmosphere to form an ODS film covering the photocatalyst layer 32. In the present embodiment, the ODS film on the photocatalyst layer 32 is referred to as the liquid repelling layer 33. Similar to the first embodiment, the part of the liquid repelling layer 33 corresponding to the black matrix 5 is designated the first part 33a. Moreover, the part corresponding to the light transmitting area 5a regulated by the black matrix 5 is referred to as the “second part 33b.” The ODS film is a silane compound with carbon chains of 18 carbon atoms, and is an example of an organic film configured by organic molecules containing hydrocarbon chains of four or more carbon atoms.

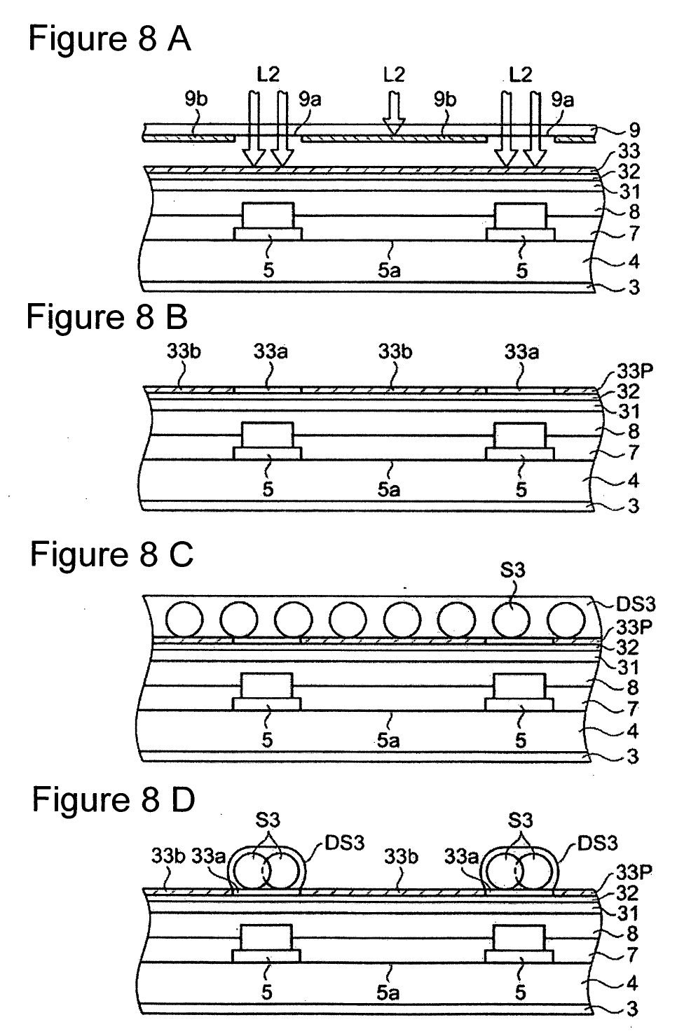

Next, the liquid repelling layer 33 is patterned to form the liquid repelling pattern 33p, as shown in FIGS. 8A and 8B. Specifically, the liquid repelling pattern 33p is formed by reducing the degree of liquid repellency of the first part 33a to less than the degree of liquid repellency of the second part 33b.

More specifically, the liquid repelling layer 33 is irradiated through the mask pattern 9 by light L2 having a wavelength of 254 nm. More specifically, the liquid repelling layer 33 is irradiated through the mask pattern 9 by a light L2 with a wavelength of 254 nm. The mask pattern 9 has a light transmitting part 9a corresponding to the black matrix 5, and a light blocking part 9b corresponding to the plurality of pixel regions G. The light L2 irradiates the light transmitting part 9a of the mask pattern 9 overlaying the black matrix 5. As a result, the first part 33a of the liquid repelling layer 33 is irradiated by the light L2 with a wavelength of 254 nm. The second part 33b of the liquid repelling layer 33 is not irradiated by the light L2.

As shown in FIG. 8B, the degree of liquid repellency of the first part 33a is reduced to less than the degree of liquid repellency of the second part 33b by the irradiation of the first part 33a by light having the above mentioned wavelength. Specifically, the difference between the contact angle formed by the dispersion fluid DS3 described later and the first part 33a, and the contact angle formed by the dispersion fluid DS3 and the second part 33b is 10° or greater.

More specifically, the light of the above mentioned wavelength activates the photocatalyst in the photocatalyst layer 32 and causes dissociation, cleavage, migration, and oxidation of the molecules in the first part 33a, and bonding among like molecules in the first part 33a, or bonding of hydrogen atoms or oxygen atoms in the first part 33a. Then, the first part 33a becomes lyophilic relative to the dispersion fluid DS3 by the chemical reaction produced in the first part 33a. In the present embodiment, the contact angle of the light of the above mentioned wavelength relative to water of the first part 33a is less than 80°. The contact angle relative to the water of the second part 23b is maintained at 90° or greater.

Then, a dispersion fluid DS3 is provided or applied on the liquid repelling pattern 33p, as shown in FIG. 8C. The dispersion fluid DS3 includes water, which functions as a dispersion medium, and spacers S3, which have a 4 μm diameter and are dispersed in the water. Beads treated with a thermal surface hardening process produced by Sekisui Chemical Co., Ltd., may be used as the spacers S3. When the dispersion fluid DS3 is provided so as to cover the liquid repelling pattern 33p, the dispersion fluid DS3 is self-organized or self-arranged relative to the liquid repelling pattern 33p, as shown in FIG. 8D. Specifically, nearly all of the dispersion fluid DS3 collects in the first part 33a which has lower relative liquid repellency by means of the surface tension of the dispersion fluid DS3. In this case, the water dispersion medium and the spacers S3 collect in the first part 33a. Moreover, neither the dispersion medium nor the spacers S3 remain in the second part 33b, which has a higher liquid repellency. Since the dispersion medium is water, there is no residue remaining in the pixel region G or the second part 33b.

Since the liquid repellency remains in the part corresponding to the pixel region G (second part 33b), the spacers S3 can be removed from the part where the spacers S3 should not remain (second part 33b), for example, even when the dispersion fluid DS3 is uniformly applied to the liquid repelling pattern 33p. Thus, since no spacers S3 remain in the pixel region G, there is no light scattering caused by the spacers S3 when an image is displayed on the liquid crystal display device.

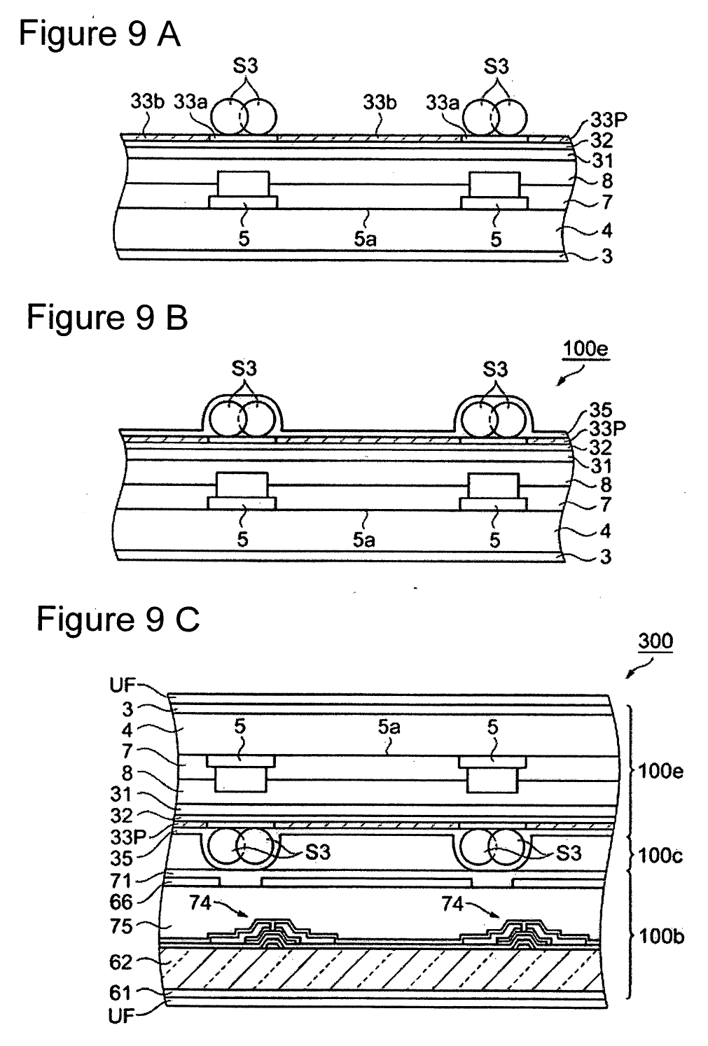

Thereafter, the base 1c provided with the spacers S3 is heated to evaporate the dispersion fluid (water), as shown in FIG. 9A. Finally, a thermosetting resin configuring the surface of the spacers S3 is hardened by this heating. Then, the spacers S3 are not only mutually adhered on the first part 33a, the spacers S3 are also adhered to the surface of the first part 33a.

Then, an orientation film 35 is formed to cover the spacers S3 on the first part 33a and the second part 33b, as shown in FIG. 9B. The thickness of the orientation film 35 is approximately 30 nm. The obtained orientation film 35 is then subjected to a rubbing process to obtain the color filter substrate 100e.

The color filter substrate 100e of the present embodiment is formed by the above processes. Thereafter, the element substrate 100b described in the first embodiment is adhered to the color filter substrate 100e. Then, liquid crystal material is loaded in the gap between the element substrate 100b and the color filter substrate 100e to form a liquid crystal layer 100c, and thus obtain the liquid crystal display device 300 shown in FIG. 9C.

As shown in FIG. 9C, the liquid crystal display device 300 may also be provided with two ultraviolet filters UF in addition to the previously described structural elements. In this case, the two ultraviolet filters UF are provided such that the color filter substrate 100e, element substrate 100b, and liquid crystal layer 100c are disposed between the ultraviolet filters UF. In this case, since ultraviolet light included in the light from the light source (not shown in the drawings) and ultraviolet light included in the exterior light do not enter the photocatalyst layer 32, a light reaction is not generated in the organic layer of the orientation film 35, and as a result the photocatalyst layer 32 does not cause deterioration of the organic layer in the color filter substrate 100e. Moreover, if the ultraviolet light from the exterior light has an intensity that can be ignored, the ultraviolet light filter UF may be omitted on the side from which the exterior light enters. Furthermore, if the ultraviolet light included in the light from the light source can be ignored, as in the case of an LED light source, the ultraviolet filter also may be omitted on the light source side.

### Fourth Embodiment

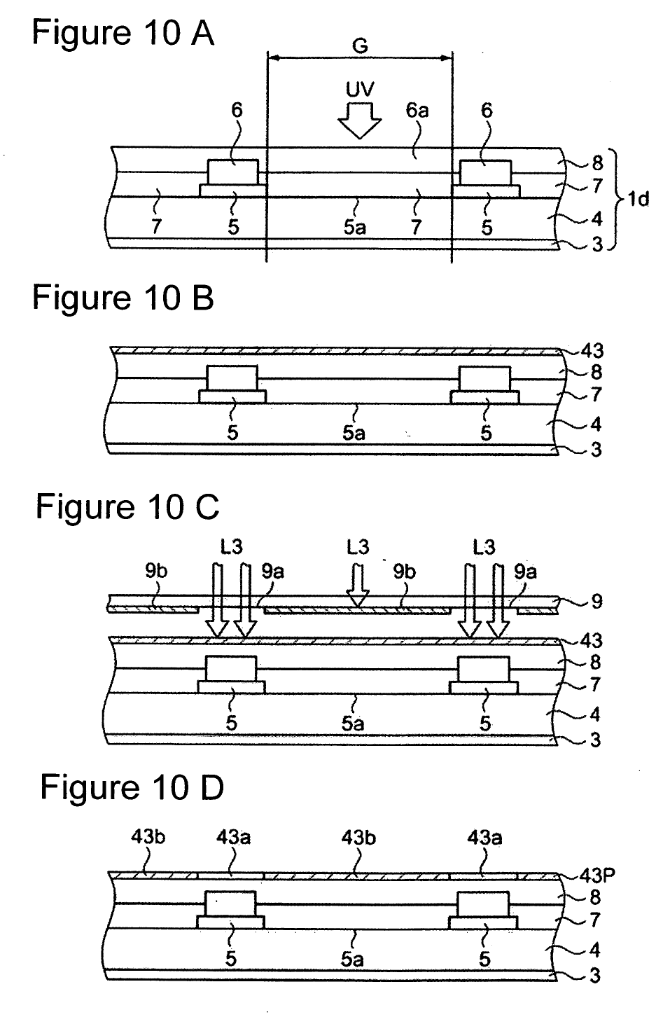

In the fourth embodiment, the overcoat layer 8 is first irradiated with ultraviolet light UV to wash the surface of the overcoat layer 8, as shown in FIG. 10A. The substrate 1d of the present embodiment includes a polarization panel 3, substrate 4, color filter element 7, black matrix 5, bank pattern 6, and overcoat layer 8. The surface of the overcoat layer 8 is equivalent to the surface of the base of the present embodiment.

Next, a photosensitive molecular film (preferably a monomolecular film) is formed to cover the overcoat layer 8, as shown in FIG. 10B. The thickness of the photosensitive molecular film is less than 100 nm. The material of the photosensitive molecular film may be photodegradable silane coupling agent disclosed in Japanese Patent Application Publication No. 2003-321479, or a photosensitive silane disclosed in Japanese Patent Application Publication No. 6-202343 or the like. In the present embodiment, the photosensitive molecular film on the overcoat layer 8 is referred to as liquid repelling layer 43. Similar to the first embodiment, the part of the liquid repelling layer 43 corresponding to the black matrix 5 is designated as the first part 43a. Moreover, the part corresponding to the light transmitting area 5a regulated by the black matrix 5 is referred to as the “second part 43b.” Japanese Patent Application Publication No. 2003-321479 and Japanese Patent Application Publication No. 6-202343 are hereby incorporated herein by reference.

A liquid repelling pattern 43p is formed for patterning the liquid repelling layer 43, as shown in FIGS. 10C and 10D. Specifically, the liquid repelling pattern 43p is formed by reducing the degree of liquid repellency of the first part 43a to less than the degree of liquid repellency of the second part 43b.

More specifically, the liquid repelling layer 43 is irradiated through the mask pattern 9 by a light L3 having a wavelength of 365 nm or 254 nm. The mask pattern 9 has a light transmitting part 9a corresponding to the black matrix 5, and a light blocking part 9b corresponding to the plurality of pixel regions G. The light L3 irradiates the light transmitting part 9a of the mask pattern 9 overlaying the black matrix 5. As a result, the first part 43a of the liquid repelling layer 43 is irradiated by the light L3 having a wavelength of 365 nm or 254 nm. The second part 43b of the liquid repelling layer 43 is not irradiated by the light L3.

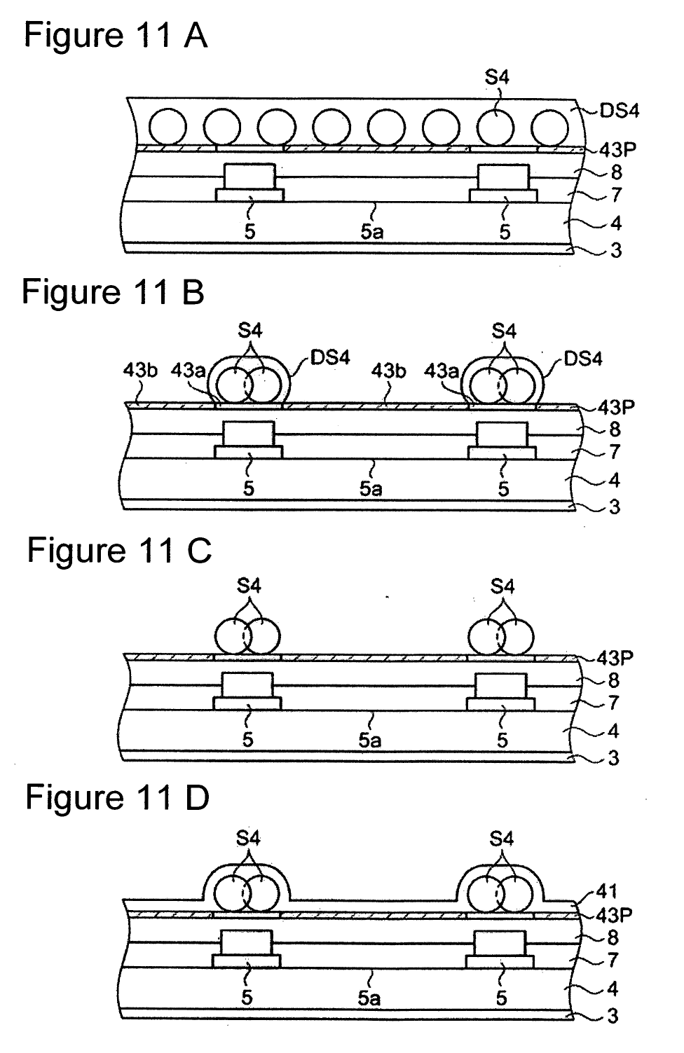

As shown in FIG. 10D, the degree of liquid repellency of the first part 43a is reduced to less than the degree of liquid repellency of the second part 43b by the irradiation of the first part 43a by light having the above mentioned wavelength. Specifically, the difference between the contact angle formed by the dispersion fluid DS4 (FIG. 11) and the first part 43a, and the contact angle formed by the dispersion fluid DS4 and the second part 43b is 10° or greater.

More specifically, the light of the above mentioned wavelength causes dissociation, cleavage, migration, and oxidation of the molecules in the first part 43a, and bonding among like molecules in the first part 43a, or bonding of hydrogen atoms or oxygen atoms in the first part 43a. Then, the first part 43a becomes lyophilic relative to the dispersion fluid DS4 by the chemical reaction produced in the first part 43a. In the present embodiment, the contact angle of the light of the above mentioned wavelength relative to the water of the first part 13a is less than 80°. The contact angle relative to the water of the second part 23b is maintained at 90° or greater.

Then, as shown in FIG. 11A, a dispersion fluid DS4 is provided or applied on the liquid repelling pattern 43p. The dispersion fluid DS4 includes water, which functions as a dispersion medium, and spacers S4, which have a 5 μm diameter and are dispersed in the water. Natco spacers, manufactured by Natco Company, Ltd., may be used as the spacers S4. When the dispersion fluid DS4 is provided so as to cover the liquid repelling pattern 43p, the dispersion fluid DS4 is self-organized or self-arranged relative according to the liquid repelling pattern 43p, as shown in FIG. 11B. Specifically, nearly all of the dispersion fluid DS4 collects in the first part 43a which has lower relative liquid repellency by means of the surface tension of the dispersion fluid DS4. In this case, the water dispersion medium and the spacers S4 collect in the first part 43a. Moreover, neither the dispersion medium nor the spacers S4 remain in the second part 43b, which has a higher liquid repellency. Since the dispersion medium is water, there is no residue remaining in the pixel region G or the second part 43b.

Since the liquid repellency remains in the part corresponding to the pixel region G (second part 43b), the spacers S4 can be removed from the part where the spacers S4 should not remain (second part 43b), for example, even when the dispersion fluid DS4 is uniformly applied to the liquid repelling pattern 43p. Thus, since no spacers S4 remain in the pixel region G, there is no light scattering caused by the spacers S4 when an image is displayed on the liquid crystal display device.

Thereafter, the substrate 1d provided with the spacers S4 is heated to evaporate the dispersion fluid (water), as shown in FIG. 11C. Then, the spacers S4 remain only in the first part 43a.

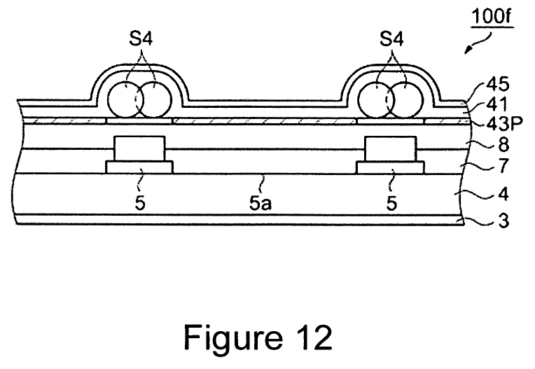

Then, a common electrode 41 is formed to cover the spacers S4 on the first part 43a and the second part 43b, as shown in FIG. 11D. Specifically, an ITO common electrode 41 is formed on the base provided with the spacers S4 by spatter vacuum deposition. Next, an orientation film 45 is formed to cover the common electrode 41, as shown in FIG. 12. The orientaiton film 45 is a polyimide film approximately 30 nm in thickness. Thereafter, the obtained orientation film 45 is subjected to a rubbing process to obtain the color filter substrate 100f.

The color filter substrate 100f of the present embodiment is formed by the above processes. Thereafter, the element substrate 100b described in the first embodiment is adhered to the color filter substrate 100f. Then, liquid crystal material is loaded in the gap between the element substrate 100b and the color filter substrate 100f to form a liquid crystal layer 100c, and thus obtain a liquid crystal display device.

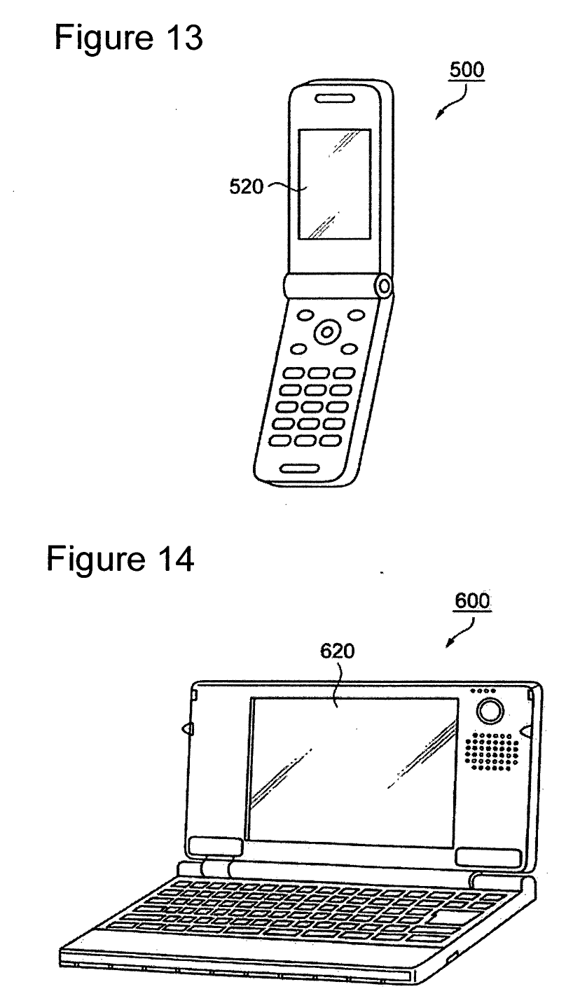

The manufacturing methods described in the first through fourth embodiments are applicable to methods for manufacturing various electronic devices. For example, the manufacturing methods of the present embodiments are applicable to methods for manufacturing a portable telephone 500 provided with a liquid crystal display device 520, as shown in FIG. 13, and applicable to methods for manufacturing a personal computer 600 provided with a liquid crystal display device 620, as shown in FIG. 14.

This application claims priority to Japanese Patent Application No. 2005-011174. The entire disclosure of Japanese Patent Application No. 2005-011174 is hereby incorporated herein by reference.

What is claimed is:

1. A method for manufacturing a function substrate to be used in a liquid crystal display device having a black matrix, the method comprising:
forming a liquid repelling layer that covers a surface of a substrate;
irradiating through a mask pattern with light a first part of the liquid repelling layer that corresponds to the black matrix, such that the liquid repellency of the first part is reduced relative to that of other parts of the liquid repelling layer; and
covering the liquid repelling layer, after the irradiation, with a dispersion fluid in which spacers are dispersed.

2. The method for manufacturing a function substrate of claim 1, further comprising:
providing a photocatalyst layer on the surface of the substrate; and
wherein the liquid repelling layer is formed on the photocatalyst layer.

3. The method for manufacturing a function substrate of claim 2, wherein
the photocatalyst layer is formed by providing on the surface micro particles of one or more materials selected from among silica, titanium oxide, zinc oxide, tin oxide, strontium titanate, tungsten oxide, bismuth oxide, and iron oxide.

4. The method for manufacturing a function substrate of claim 1, wherein
the forming of the liquid repelling layer includes forming a high polymer compound containing fluorine on the surface as the liquid repelling layer.

5. The method for manufacturing a function substrate of claim 1, wherein
the forming of the liquid repelling layer includes forming on the surface of the substrate an organic film formed of organic molecules containing fluorine as the liquid repelling layer.

6. The method for manufacturing a function substrate of claim 1, wherein
the forming of the liquid repelling layer includes introducing fluorine on the surface of the substrate using a fluorocarbon compound in a reaction gas, and thereby forming the liquid repelling layer.

7. The method for manufacturing a function substrate of claim 1, wherein
the forming of the liquid repelling layer includes forming on the surface of the substrate an organic film formed of organic molecules with a hydrocarbon chain of four or more carbon atoms as the liquid repelling layer.

8. The method for manufacturing a function substrate of claim 1, wherein
the forming of the liquid repelling layer includes forming on the surface of the substrate a photosensitive molecule layer as the liquid repelling layer.

9. A color filter substrate manufactured by the method for manufacturing a function substrate of claim 1.

10. A liquid crystal display device provided with the color filter substrate of claim 9.

11. An electronic device provided with the liquid crystal display device of claim 10.
